(19) United States
(12) Patent Application Publication
(10) Pub. No.: US 2004/0058283 A1
(43) Pub. Date: Mar. 25, 2004

(54) Bleach-fixing concentrate

(76) Inventors: Gustav Tappe, Leverkusen (DE); Wolfgang Korner, Leverkusen (DE)

Correspondence Address: CONNOLLY BOVE LODGE & HUTZ, LLP, P O BOX 2207, WILMINGTON, DE, 19899, US

(21) Appl. No.: 10/668,579

(22) Filed: Sep. 23, 2003

Related U.S. Application Data
(62) Division of application No. 09/865,880, filed on May 25, 2001.

(30) Foreign Application Priority Data
May 27, 2000 (DE) DE 100 26 456.5
Aug. 3, 2000 (DE) DE 100 37 765.3
Aug. 14, 2000 (DE) DE 100 39 719.0

(51) Int. Cl. G03C 7/42

(52) U.S. Cl. 430/460; 430/393

(57) ABSTRACT

A one-part photographic bleach-fixing concentrate containing an iron(III) complex salt, a thiosulphate and a sulphite, a disulphite or a sulphinic acid, remains stable if a phosphate, polyphosphate or polyphosphonate, or a nitrate or bromide is added thereto.

This invention relates to a one-part bleach-fixing concentrate (BX concentrate) with which bleach-fixing baths can be made up or regenerated, and also relates to a bleach-fixing bath.

BX baths are used in colour photographic processing in order to oxidise the silver formed by development into a soluble form thereof (bleaching) and in order to dissolve it in this form, together with undeveloped silver halide, by forming a complex from the material to be dissolved (fixing). For these purposes, BX baths contain a series of necessary chemicals, namely an iron(III) complex salt as an oxidant, a thiosulphate as a fixing agent, and a sulphite, a disulphite or a sulphinic acid as a stabiliser for the thiosulphate. These chemicals exert an effect on each other, so that they cannot be held for an extended period in the same solution. For example, the iron(III) complex salt oxidises the sulphite, the disulphite or the sulphinic acid. The thiosulphate is thereby no longer stabilised, so that it then decomposes.

For this reason, BX baths are produced as two or three parts which are not combined with each other until just before they are used. Concentrates which are required for regeneration, i.e. for subsequent addition to spent chemicals, are likewise produced as two or three parts.

Multi-part production of the constituents of a BX tank bath or of a BX regenerator is disadvantageous, firstly because it is costly and uneconomic, and secondly because it results, time after time, in errors of addition.

There is therefore a great need for the chemicals for BX baths to be produced as one part, and in particular there is a need to provide a one-part BX concentrate which can be converted very easily, namely by dilution with water, to a ready-to-use BX bath, or which can be used just as easily for regenerating a BX bath. Attempts to satisfy these needs have hitherto failed because of the aforementioned decomposition of the thiosulphate, and also due to insufficient solubility of the thiosulphate, of the sulphite and of the iron(III) complex salt, particularly if the latter is iron(III)-EDTA.

Surprisingly, it has now been found that these disadvantages can be overcome if at least one compound from the series comprising a phosphate, polyphosphate or polyphosphonate, or a nitrate or bromide, is added to the BX concentrate containing the aforementioned constituents.

Complex salts of Fe(III) which are suitable for photographic bleaching and bleach-fixing batchs are known from numerous documents (e.g. EP 329 088, 584 665, 507 126, 556 782, 532 003, 750 226, 657 777, 599 620, 588 289, 723 194, 851 287, 840 168, 871 065, 567 126, 726 203 and U.S. Pat. No. 5,670,305).

The preferred complexing agents for Fe(III) are: ethylenediaminetetraacetic acid (EDTA), propylenediaminetetraacetic acid (PDTA), β-alaninediacetic acid (ADA), diethylenetriaminepentaacetic acid (DTPA), methyliminodiacetic acid (MIDA), ethylenediamine monosuccinate (EDMS), methylglycinediacetic acid (MGDA), ethylenediamine disuccinate (EDDS), particularly (S,S)-EDDS, iminosuccinic acid, iminosuccinic acid-propionic acid, and 2-hydroxypropyliminodiacetic acid.

Mixtures of complexing agents can also be used.

Examples of suitable sulphites include ammonium sulphite, ammonium hydrogen sulphite, sodium sulphite, sodium disulphite, sodium hydrogen sulphite, potassium sulphite, potassium disulphite and potassium hydrogen sulphite. Examples of suitable sulphinic acids include hydroxymethanesulphinic acid, formamidinesulphinic acid, benzenesulphinic acid, p-toluenesulphinic acid, methanesulphinic acid, o-amido-sulphinic acid and salts thereof.

Alkali salts and/or ammonium salts can be used as phosphates, e.g. ammonium di-hydrogen phosphate, diammonium hydrogen phosphate, triammonium phosphate, potassium dihydrogen phosphate, dipotassium hydrogen phosphate, tripotassium phosphate, sodium dihydrogen phosphate, disodium hydrogen phosphate, and tri-sodium phosphate or free phosphoric acid.

Examples of polyphosphates and polyphosphonates which can be used include sodium hexametaphosphate, sodium tetraphosphate, hydroxyethanediphosphonic acid, N(-2-carboxyethyl)-1-aminoethane-1,1-diphosphonic acid, N,N-bis-(carboxy-methylene)-1-aminoethane-1,1-diphosphonic acid, morpholinomethane-diphosphonic acid, nitrilotrismethylene-phosphonic acid, ethylenediamine-tetramethylene phosphonic acid, hexamethylenediaminetetramethylene phosphonic acid, 2-phospono-butane-1,2,4-tricarboxylic acid, and 2-carboxyethane-phosphonic acid. Free poly-phosphoric acids are also suitable.

Alkali and/or ammonium nitrates and bromides can be used as nitrates and bromides.

The phosphates, polyphosphates and polyphosphonates, nitrates and bromides are preferably added to the concentrate in an amount ranging from 0.01 to 2.5 mol/litre, particularly from 0.05 to 1 mol/litre.

Sodium, potassium and ammonium thiosulphates are particularly suitable as fixing agents.

Other constituents can include aminopolycarboxylic acids, rehalogenating agents, acids and alkalies for pH adjustment, bleaching accelerators, white couplers and buffer substances (see Research Disclosure 37 038, February 1995, pages 107 to 109).

In particular, the pH ranges from 4 to 9.

In addition, other complexing agents can also be added, individually or in admixture. These include:

polycarboxylic acids: e.g. oxalic acid, malonic acid, glutaric acid, adipic acid, suberic acid, fumaric acid, maleic acid, itaconic acid;

(poly)hydroxypolycarboxylic acids: e.g. citric acid, glycolic acid, lactic acid, malic acid, tartaric acid, galactaric acid.

These additional complexing agents are preferably added in an amount from 1 to 200 mmol/l, particularly in an amount from 5 to 50 mmol/l concentrate.

The present invention further relates to a ready-to-use bleach-fixing bath of the type cited at the outset, which is characterised in that it additionally contains a phosphate, particularly in an amount from 0.01 to 0.6 mol/litre, and a polycarboxylic acid or (poly)hydroxypolycarboxylic acid, particularly in an amount from 0.5 to 50 mmol/litre.

The bleach-fixing bath can be produced from the concentrate according to the invention if the concentrate contains phosphate and/or polyphosphate.

### EXAMPLES

### Example 1

1 litre of BX concentrate contained

| ammonium thiosulphate solution, 57% by weight | 400 ml |
|---|---|
| ammonium hydrogen sulphite solution, 66% by weight | 80 ml |
| NH₄Fe(III)EDTA solution, 48% by weight | 330 ml |
| additives | see below |
| pH | 5.5 |

The pH was adjusted with NH₃ or H₂SO₄.

The following additions were made to BX concentrates:

BX 1: no additives

BX 2: 40 g/l sodium acetate (0.49 mol/litre)

BX 3: 186 g/l trisodium phosphate dodecahydrate (0.49 mol/litre)

BX 4: 50 g/l sodium hexametaphosphate (0.082 mol/litre)

BX 5: 73 ml/l aminotrismethylene-phosphonic acid, concentration 50% by weight (0.16 mol/litre)

| Storage at 60° C. | Sodium sulphite content [g/l] | | | | |
|---|---|---|---|---|---|
| Duration of storage | BX 1 | BX 2 | BX 3 | BX 4 | BX 5 |
| No storage | 82.7 | 82.5 | 82.4 | 82.6 | 82.3 |
| 2 days | 55.6 | 56.0 | 65.4 | 64.9 | 65.1 |

| | | | | |
|---|---|---|---|---|
| 6 days | Precipitates of sulphur | 54.0 | 54.2 | 53.8 |

The stability of the sulphite was considerably improved by the addition of phosphate, polyphosphate and polyphosphonate.

The BX concentrate according to the invention can be used without disadvantages instead of a conventional, two-part BX concentrate, for example in the standard AP 94 process for the bleach-fixing of exposed, developed colour paper based on chloride-rich silver halide emulsions.

### Example 2

The following additions were made to a BX concentrate as in Example 1 (no additives):

BX 1: no additives

BX 2: 40 g/l sodium acetate (0.49 mol/litre)

BX 3: 48.5 g/l ammonium dihydrogen phosphate (0.49 mol/litre)

BX 4: 48 g/l ammonium bromide (0.49 mol/litre)

BX 5: 73 g/l ammonium nitrate (0.49 mol/litre)

BX 6: 48.5 g/l ammonium dihydrogen phosphate (0.49 mol/l), 20 g/l EDTA acid; 8 g/l citric acid;

BX 7: 48.5 g/l ammonium dihydrogen phosphate (0.49 mol/l), 16 g/l citric acid.

| | Formation of crystals |
|---|---|
| BX concentrate | after 5 days at −5° C. |
| BX 1 | crystals |
| BX 2 | crystals |
| BX 3 | no crystals |
| BX 4 | no crystals |
| BX 5 | no crystals |
| BX 6 | no crystals |
| BX 7 | no crystals |

The addition of phosphate, bromide or nitrate prevents the formation of crystals in a one-part bleach-fixing concentrate, so that a stable concentrate which comprises contents of active ingredients which would otherwise not be possible can also be produced.

The BX concentrate according to the invention is particularly suitable for short processing times (CD and BX times ranging from 12 to 35 seconds) and for a colour developer (CD) which contains disulphoethylhydroxylamine (HADS) as an anti-oxidant.

### Example 3

A ready-to-use bleach-fixing bath was produced from the following components:

| | |
|---|---|
| Ammonium thiosulphate solution, 57% by weight | 90 ml |
| sodium sulphite | 10 g |
| NH₄Fe(IIl)EDTA solution, 48% by weight | 70 ml |
| potassium dihydrogen phosphate | 20 g |
| sodium hexametaphosphate | 5 g |
| Made up with water to 1 litre | |

The pH was adjusted to 6.5 with ammonia or phosphoric acid

This bleach-fixing bath is distinguished by the improved stability of the sulphite.

It can be produced from a concentrate according to the invention.

### Example 4

A ready-to-use bleach-fixing bath was produced from the following components:

| | |
|---|---|
| Ammonium thiosulphate solution, 57% by weight | 90 ml |
| sodium sulphite | 10 g |
| NH₄Fe(III)EDTA solution, 48% by weight | 70 ml |
| potassium dihydrogen phosphate | 20 g |
| EDTA acid | 2 g |
| citric acid | 1 g |
| Made up with water to 1 litre | |

The pH was adjusted to 6.5 with ammonia or phosphoric acid

The bleach-fixing bath is distinguished by the improved stability of the sulphite.

It can be produced from a concentrate according to the invention.

1. A one-part photographic bleach-fixing concentrate containing an iron(III) complex salt, a thiosulphate and a sulphite, a disulphite or a sulphinic acid, characterised in that it additionally contains at least one compound from the series comprising a phosphate, polyphosphate or polyphosphonate, or a nitrate or bromide.

2. A one-part bleach-fixing concentrate according to claim 1, characterised in that its content of thiosulphate is 0.5 to 5 mol/litre, its content of sulphite is 0.2 to 4 mol/litre and its content of Fe(III) complex salt is 0.1 to 1 mol/litre.

3. A one-part bleach-fixing concentrate according to claims 1 or 2, characterised in that its pH is 4 to 9.

4. A one-part bleach-fixing concentrate according to claims 1 or 2, characterised in that its pH is 5 to 6.5.

5. A one-part bleach-fixing concentrate according to any of claims 1 to 4, characterised in that the amount of phosphate, polyphosphate, polyphosphonate, nitrate or bromide is 0.01 to 2.5 mol/litre.

6. A one-part bleach-fixing concentrate according to any of claims 1 to 5, characterised in that it additionally contains one or more complexing agents.

7. A one part bleach-fixing concentrate according to claim 6, characterised in that the additional complexing agent is a polycarboxylic acid or a (poly)-hydroxy polycarboxylic acid.

8. A one part bleach-fixing concentrate according to claim 6, characterised in that the additional complexing agent is citric acid.

9. A one-part photographic bleach-fixing concentrate containing an iron(III) complex salt, a thiosulphate, and a sulphite, a disulphite or a sulphinic acid, characterised in that it additionally contains a phosphate, polyphosphate or polyphosphonate.

10. A ready-to-use bleach-fixing bath containing an iron(III) complex salt, a thio-sulphate, and a sulphite, a disulphite or a sulphinic acid, characterised in that it additionally contains a phosphate and a polycarboxylic acid or a (poly)-hydroxycarboxylic acid.

11. A ready-to-use bleach-fixing bath according to claim 10, characterised in that the phosphate is contained in an amount from 0.01 to 0.6 mol and the polycarboxylic acid or (poly)hydroxycarboxylic acid is contained in an amount from 0.5 to 50 mmol per litre.

12. A ready-to-use bleach-fixing bath according to claims 10 and 11, characterised in that it is produced from a concentrate according to any of claims 1 to 9.
